(19) United States
(12) Patent Application Publication
(10) Pub. No.: US 2026/0242222 A1
(43) Pub. Date: Aug. 20, 2026

(54) FREE-FLOWING FOOD GRADE SODIUM NITRITE AND PRODUCTION METHOD THEREOF

(71) Applicant: Deepak Nitrite Limited, Vadodara (IN)

(72) Inventors: A S SARMA, Vadodara (IN); Jignesh DESAI, Vadodara (IN); Sanjay BHALEKAR, Vadodara (IN)

(21) Appl. No.: 19/641,635

(22) Filed: Apr. 8, 2026

Related U.S. Application Data
(62) Division of application No. 18/023,182, filed on Sep. 6, 2021.

(30) Foreign Application Priority Data
Sep. 7, 2020 (IN) 202021019409

(51) Int. Cl. C01B 21/50; A23B 2/788

(52) U.S. Cl. CPC C01B 21/50; A23B 2/788; C01P 2004/02; C01P 2004/80; C01P 2006/80

(57) ABSTRACT

A method of obtaining a free-flowing food grade sodium nitrite, wherein the method including steps of charging a predefined amount of water in a reactor; adding dry powder of sodium nitrite (SNI) having predefined purity in the reactor under stirring conditions to obtain SNI liquor of mass sodium nitrite; heating the SNI liquor of mass sodium nitrite at 40-60° C. under stirring to completely dissolve the dry powder and transfer to evaporator feed tank through filters; feeding the SNI liquor of mass sodium nitrite in the evaporator to concentrate liquor to obtain slurry mass of SNI having 30 to 40% free salt concentration; filtering the slurry mass of SNI through centrifuge at a temperature within a range of 50° C.-65° C. to separate wet cake and mother liquor (ML), wherein the ML goes back to an external SNI liquor; drying the wet cake using a drying unit at a temperature within a range of 100° C.-140° C. continuously with cold zone operating at 25-60° C. to obtain dry SNI material; and coating the dry SNI material with a food grade additive in a blender to obtain free-flowing food grade sodium nitrite.

### CROSS-REFERENCE TO RELATED APPLICATIONS AND PRIORITY

The present Application is a divisional application of U.S. patent application Ser. No. 18/023,182 filed on 6 Sep. 2021, which claims priority from Indian Patent Application number 202021019409 filed on 07th September 2020, the entirety of which is incorporated herein by reference in its entirety.

### TECHNICAL FIELD

The present subject matter described herein, in general, relates to a modified nitrite-based salts comprising a food grade property. In particular, the present subject matter is related to a food grade sodium nitrite and method of producing the food grade sodium nitrite.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Sodium Nitrite (NaNO₂) (hereinafter referred as SNI) is an inorganic compound in the form of salt of nitrogen oxides (NOx). The form of sodium nitrite is yellowish white crystalline solids. SNI has many applications as one of the starting material or as an additive to the compositions. SNI is also used in many sorts of industries such as food additive, curing processes, color enhancers, intermediates of drugs, and source of oxides of nitrogen.

Now-a-days, food has become a common source of toxicants exposure in human body. There are more than 2000 chemical substances added to food to modify or impart color, flavor, properties, quality and shelf life of food. In state of the art, food additives are neither ingested as nutrient nor as a food itself, but it is intentionally added to food in minuscules as preservative, color additive, enhancers, emulsifiers, stabilizers, thickeners and anti-caking agents. Preservative-type food additives can be found in anything from canned fruits and vegetables to breads and meats. There are many food additives which are used as preservatives and color enhancers, such as sodium nitrite.

Such food additives are not considered as “nutritional” but sometimes may become toxic and carcinogenic. It is known in state of the art that “no additive shall be deemed to be safe if it is found to induce cancer when ingested by man or animal”.

The current research discloses that, when nitrites react with amine-containing food or drugs, they convert to compounds known as nitrosamines, which are known to cause cancer, according to the New Hampshire Department of Environmental Services.

The sodium nitrite when used as preservatives fights harmful bacteria in ham, salami and other processed and cured meats and also maintains their pink coloration. If used in minor quantities, Sodium nitrite is safe to consume as a food additive.

In developing countries like India, industrial production of Sodium nitrite (NaNO2) is carried out at a manufacturing plant, wherein various components/machines are installed within a limited space/area. In one scenario, the SNI packing unit may be installed within a small distance from a component such as a boiler unit. The boiler unit may emit pollutants such as hazardous air pollutants (HAPs), particle pollutants, dust particles and volatile organic compounds (VOC). These pollutants may pollute the final SNI product at the time of packaging and hence this final SNI product is not consumable due to presence of the pollutants. Further, due to adverse climatic conditions in these countries, the SNI product becomes non-consumable.

Therefore, there is a long felt need to develop food grade SNI which is consumable, and which meets the standard global specifications.

### SUMMARY

Before the present system and its components are described, it is to be understood that this disclosure is not limited to the particular system and its arrangement as described, as there can be multiple possible embodiments which are not expressly illustrated in the present disclosure. It is also to be understood that the terminology used in the description is for the purpose of describing the particular versions or embodiments only and is not intended to limit the scope of the present application. This summary is not intended to identify essential features of the claimed subject matter nor it is intended for use in detecting or limiting the scope of the claimed subject matter.

In one implementation, the present subject matter describes about a method of obtaining a free-flowing food grade sodium nitrite. The method may comprise a step of charging a predefined amount of Potable water in a reactor. The method may comprise a step of adding dry powder of sodium nitrite (SNI) having predefined purity in the reactor under stirring conditions to obtain SNI liquor of mass sodium nitrite. The method may further comprise a step of heating the SNI liquor of mass sodium nitrite at 40° C.-60° C. under stirring to completely dissolve the dry powder and transfer to evaporator feed tank through filters. The method may further comprise a step of feeding SNI liquor of mass sodium nitrite in the evaporator to concentrate liquor to obtain slurry mass of SNI having 30 to 40% free salt concentration. The method may comprise a step of filtering the slurry mass of SNI through centrifuge at a temperature within a range 50° C.-65° C. to separate wet cake and Mother Liquor (ML). Further, the ML goes back to an external SNI plant to be utilized for manufacturing of regular grade SNI. Further, the method may comprise a step of drying the wet cake using a drying unit the SNI mass at temperature 100° C.-140° C. continuously with cold zone operating at 25° C.-60° C. to obtain dry SNI material. The method may further comprise a step of coating the dry SNI material with a food grade additive in a blender to obtain free-flowing food grade sodium nitrite.

In one implementation, a form of a free-flowing food grade sodium nitrite, is disclosed. The form of the free-flowing food grade sodium nitrite comprising: sodium nitrite (SNI) having purity of 99.0%-99.9%, wherein NaNO3 is no greater than 0.70%, wherein alkalinity as Na2CO3 is no greater than 600 ppm, wherein a chloride content is no greater than about 50 ppm, wherein a sulphate content is no greater than 50 ppm, wherein loss on drying is no greater than 0.2%, wherein a content of insoluble is no greater than 0.4%, wherein a content of a heavy metal is no greater than 10 ppm, and wherein a content of assay is within a range of 98.5% to 100.5%.

### BRIEF DESCRIPTION OF FIGURES

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates a method (100) for developing of free-flowing food grade Sodium nitrite (SNI), in accordance with an embodiment of the present subject matter.

FIG. 2A-2E illustrates microscopic images of the free-flowing food grade Sodium nitrate, in accordance with the Exp. no 1-5 of the present subject matter.

FIG. 3 illustrates Process Flow diagram (PFD) depicting an interaction between various components for obtaining the free-flowing food grade Sodium nitrite (SNI), in accordance with an embodiment of the present subject matter.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items.

It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are described. The disclosed embodiments are merely exemplary of the disclosure, which may be embodied in various forms.

In order to achieve the characteristics/properties of the free-flowing food grade SNI, the present subject matter discloses an improved process, wherein multiple process modifications are carried out based on process variables including, but not limited to, temperature adjustment, time, RPM speed of the stirrer, and adding an anticaking agent. The improved process proposed herein resulted in obtaining the free-flowing food grade SNI with optimal values of the parameters including, but are not limited to, SNI purity, NaNO3, alkalinity as NaCO3, Chloride, Sulphate, loss on drying (LOD), max insoluble, heavy metal-sum of pb, As, cd, Pb, Hg the details of which are explained hereinafter as below.

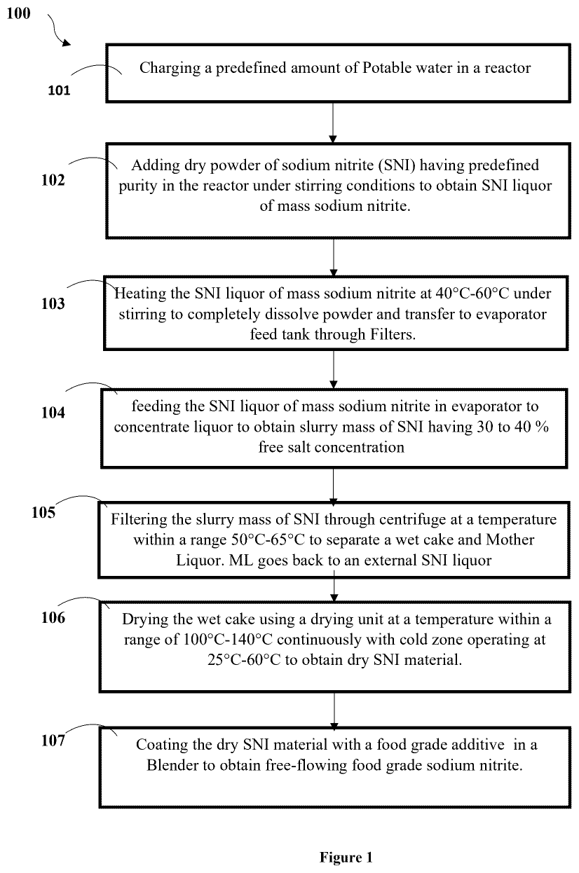

Now referring to FIG. 1, a method (100) of obtaining a free-flowing food grade sodium nitrite is depicted, in accordance with an embodiment of the present subject matter, the method (100) comprises the following steps:

At step (101), a predefined amount of water may be charged in a reactor. In one embodiment, the water may be Potable water. Test results of the potable water is given in the below table No. 1:

TABLE 1
Test results of potable water

| Sr. | | | | | Det. | |
|---|---|---|---|---|---|---|
| No | Test Name | Unit | Result | Specification | limit | Method of test |
| 1 | Description | — | Clear | — | — | — |
| | | | colourless | | | |
| | | | liquid | | | |
| | | | containing | | | |
| | | | suspended | | | |
| | | | particles | | | |
| 2 | Colour | Hazen | 1 | Max.5 | | IS: 3025[part |
| | | unit | | | | 4]-1983 |
| 3 | Odour | — | Agreeable | Agreeable | | IS: 3025 [part |
| | | | | | | 5]-1983 |
| 4 | Taste | — | Agreeable | Agreeable | | IS: 3025[part- |
| | | | | | | 7 & 8]-1984 |
| 5 | Turbidity | NTU | 0 | Max. 1 | | IS: 3025 [part |
| | | | | | | 10]-1984 |
| 6 | Total | mg/l | 114 | Max. 500 | | IS: 3025 [part |
| | dissolved | | | | | 16]-1984 |
| | solids | | | | | |
| 7 | pH | — | 7.25 | 6.5 to 8.5 | | IS: 3025 [part |
| | | | | | | 11]-1983 |
| 8 | Total | mg/l | 40.8 | Max. 200 | | IS: 3025 [part |
| | hardness as | | | | | 21]-1983 |
| | CaCO₃ | | | | | |
| 9 | Calcium as | mg/l | 30.6 | Max. 75 | | IS: 3025 [Part |
| | Ca | | | | | 40]-1991 |
| 10 | Chloride as | mg/l | 36.3 | Max. 250 | | IS: 3025 |
| | Cl | | | | | [Part-32]- |
| | | | | | | 1988 |
| 11 | Sulphate as | mg/l | 6.6 | Max. 200 | | IS: 3025 |
| | SO4 | | | | | [part-24]- |
| | | | | | | 1986 |
| 12 | Nitrate | mg/l | 2.40 | Max. 45 | | IS: 3025[part- |
| | as | | | | | 34]-1988 |
| | NO3 | | | | | |
| 13 | Total | mg/l | 51.0 | Max. 200 | | IS: 3025 |
| | Alkalinity | | | | | [part-23]- |
| | as Calcium | | | | | 1983 |
| | carbonate | | | | | |
| 14 | Magnesium | mg/l | 10.19 | Max.30 | | IS: 3025 |
| | as Mg | | | | | [Part-46]- |
| | | | | | | 1994 |
| 15 | Boron as B | mg/l | Not | Max. 0.5 | | IS: 3025 |
| | | | detected | | | [Part-57]- |
| | | | | | | 2005 |
| 16 | Copper | mg/l | Not | Max. 0.05 | | IS: 3025 |
| | as | | detected | | | [Part-42]- |
| | Cu | | | | | 1992 |
| 17 | Iron as Fe | mg/l | 0.02224 | Max. 1 | | IS: 3025[part- |
| | | | | | | 53]-2003 |
| 18 | Manganese | mg/l | Not | Max. 0.1 | | IS: 3025 |
| | as Mn | | detected | | | [part-59]- |
| | | | | | | 2006 |
| 19 | Fluoride as | mg/l | Less than | Max. 1.0 | | IS: 3025 [part- |
| | F | | 0.1 | | | 60]-2008 |
| 20 | Phenolic | mg/l | Not | Max. 0.001 | | IS: 3025 |
| | compound | | detected | | | [part-43]- |
| | as C6H5OH | | | | | 1992 |
| 21 | Mercury as | mg/l | Not | Max. 0.001 | | IS: 3025 [part- |
| | Hg | | detected | | | 48]-1994 |
| 22 | Cadmium as | mg/l | Not | Max. 0.003 | | IS: 3025 |
| | Cd | | detected | | | [part-41]- |
| | | | | | | 1992 |
| 23 | Selenium as | mg/l | Not | Max. 0.01 | | IS: 3025 |
| | Se | | detected | | | [Part-56]- |
| | | | | | | 2003 |
| 24 | Total | mg/l | Not | Max. 0.01 | | IS: 3025 [part |
| | arsenic as | | detected | | | 37]-1988 |
| | As | | | | | |
| 25 | Barium as | mg/l | Not | Max. 0.7 | | Annex F of |
| | Ba | | detected | | | IS: 13428- |
| | | | | | | 2003 |
| 26 | Chloramines | mg/l | Not | Max. 4.0 | | IS: 3025[part- |
| | as Cl2 | | detected | | | 26]-1986 |
| 27 | Sulphide as | mg/l | Less than | Max. 0.05 | | IS: 3025 |
| | H2S | | 0.05 | | | [part-29]- |
| | | | | | | 1986 |
| 28 | Molybdenum | mg/l | Not | Max. 0.07 | | IS: 3025[part- |
| | as Mo | | detected | | | 2]-2002 |
| 29 | Nickel as Ni | mg/l | Not | Max. 0.02 | | IS: 3025[part- |
| | | | detected | | | 54]-2003 |
| 30 | Silver as Ag | mg/l | Not | Max. 0.1 | | Annex J of |
| | | | detected | | | IS: 13428- |
| | | | | | | 2003 |
| 31 | Cyanide as | mg/l | Not | Max 0.05 | | IS: 3025[Part- |
| | CN | | detected | | | 27]-1986 |
| 32 | Lead as Pb | mg/l | Not | Max 0.01 | | IS: 3025 [Part- |
| | | | detected | | | 47]-1994 |
| 33 | Zinc as Zn | mg/l | Not | Max. 5.0 | | IS: 3025 |
| | | | detected | | | [Part-49]- |
| | | | | | | 1994 |
| 34 | Anionic | mg/l | Not | Max. 0.2 | | Annex k of |
| | detergent as | | detected | | | IS: 13428- |
| | MBAS | | | | | 2003 |
| 35 | Total | mg/l | Not | Max. 0.05 | | IS: 3025 |
| | chromium | | detected | | | [Part-52]- |
| | as Cr | | | | | 2003 |
| 36 | Mineral oil | mg/l | Not | Max. 0.5 | | Clause 6 of |
| | | | detected | | | IS: 3025 [part |
| | | | | | | 39]-1989 |
| | | | | | | infrared |
| 37 | Aluminum | mg/l | Not | Max. 0.03 | | IS: 3025 [part |
| | as Al | | detected | | | 55]-2003 |
| 38 | Ammonia | mg/l | Not | Max. 0.5 | | IS: 3025 [part |
| | (as total | | detected | | | 3]-1988 |
| | ammonias | | | | | |
| | N) | | | | | |
| 39 | Residual | mg/l | Not | Min. 0.2 | | IS: 3025 |
| | free | | detected | | | [Part-26]- |
| | Chlorine as | | | | | 1986 |
| | CL2 | | | | | |
| 40 | Polynuclear | mg/l | Not | Max. 0.0001 | | APHA 6440 |
| | aromatic | | detected | | | |
| | hydrocarbons | | | | | |
| | as PAH | | | | | |
| 41 | Poly | mg/l | Not | Max. | | APHA 6630 |
| | chlorinated | | detected | 0.0005 | | |
| | diphenyls | | | | | |
| 42 | Trihalo- | — | — | — | | — |
| | methanes | | | | | |
| a | Bromoform | mg/l | Not | Max. 0.1 | | APHA 6232 |
| | | | detected | | | |
| b | Dibromo- | mg/l | Not | Max. 0.1 | | APHA 6232 |
| | chloromethane | | detected | | | |
| c | Bromodichloro- | mg/l | Not | Max. 0.06 | | APHA 6232 |
| | methane | | detected | | | |
| d | Chloroform | mg/l | Not | Max. 0.2 | | APHA 6232 |
| | | | detected | | | |
| 43 | Radioactive | — | — | — | | — |
| | material | | | | | |
| a | Alpha | Bq/l | Not | Max. 0.1 | | IS14194 |
| | emitters | | detected | | | |
| b | Beta | Bq/l | Not | Max 1.0 | | IS14194 |
| | emitters | | detected | | | |
| 44 | Pesticide | — | — | — | | — |
| | residue | | | | | |
| i | Alachlor | ug/l | Not | Max 20 | | EPA 525.2 |
| | | (ppb) | detected | | | |
| ii | Atrazine | ug/l | Not | Max. 2 | | EPA 525.2 |
| | | (ppb) | detected | | | |
| iii | Aldrin/ | ug/l | Not | Max 0.03 | | EPA 508 |
| | dieldrin | (ppb) | detected | | | |
| iv | α-HCH | ug/l | Not | Max 0.01 | | EPA 508 |
| | | (ppb) | detected | | | |
| v | β-HCH | ug/l | Not | Max. 0.04 | | EPA 508 |
| | | (ppb) | detected | | | |
| vi | Butachlor | ug/l | Not | Max 125 | | EPA 525.2 |
| | | (ppb) | detected | | | |
| vii | Chlorpyriphos | ug/l | Not | Max 30 | | EPA 525.2 |
| | | (ppb) | detected | | | |
| viii | §-HCH | ug/l | Not | Max 0.04 | | EPA 508 |
| | | (ppb) | detected | | | |
| ix | 2,4-D | ug/l | Not | Max 30 | | EPA 555 |
| | | (ppb) | detected | | | (modified) |
| x | DDT | ug/l | Not | Max 1 | | EPA 508 |
| | | (ppb) | detected | | | |
| a | o, p, DDE | ug/l | Not | — | | — |
| | | (ppb) | detected | | | |
| b | o, p, DDD | ug/l | Not | — | | — |
| | | (ppb) | detected | | | |
| c | o, p, DDT | ug/l | Not | — | | — |
| | | (ppb) | detected | | | |
| d | p, p, DDE | ug/l | Not | — | | — |
| | | (ppb) | detected | | | |
| e | p, p, DDD | ug/l | Not | — | | — |
| | | (ppb) | detected | | | |
| f | p, p, DDT | ug/l | Not | — | | — |
| | | (ppb) | detected | | | |
| xi | Endosulfan | ug/l | Not | Max. 0.4 | | EPA 508 |
| | | (ppb) | detected | | | |
| a | α- | ug/l | Not | — | | |
| | Endosulfan | (ppb) | detected | | | |
| b | β- | ug/l | Not | — | | |
| | Endosulfan | (ppb) | detected | | | |
| c | Endosulfate | ug/l | Not | — | | |
| | | (ppb) | detected | | | |
| xii | Ethion | ug/l | Not | Max. 3 | | EPA 1657 |
| | | (ppb) | detected | | | |
| xiii | Lindane (y- | ug/l | Not | Max. 2 | | EPA 508 |
| | HCH) | (ppb) | detected | | | |
| xiv | Isoproturon | ug/l | Not | Max. 9 | | EPA 532 |
| | | (ppb) | detected | | | |
| xv | Malathion | ug/l | Not | Max. 190 | | EPA 8141A |
| | | (ppb) | detected | | | |
| xvi | Methyl | ug/l | Not | Max. 0.3 | | EPA 8141A |
| | parathion | (ppb) | detected | | | |
| xvii | Monocrotophos | ug/l | Not | Max. 1.0 | | EPA 8141A |
| | | (ppb) | detected | | | |
| xviii | Phorate | ug/l | Not | Max. 2 | | EPA 8141A |
| | | (ppb) | detected | | | |
| 45 | E. Coli | in 100 | Absent | Should be | | IS: 1622-1981 |
| | | ml | | absent | | |
| 46 | Total | in 100 | Absent | Should be | | IS: 1622-1981 |
| | Coliform | ml | | absent | | |
| | count | | | | | |

At step (102), dry powder of sodium nitrite (SNI) having predefined purity may be added in the reactor under stirring conditions to obtain a SNI liquor of mass sodium nitrite. In one embodiment, the dry powder of sodium nitrate added in the reactor may be stirred at a predefined RPM and specifically designed agitator. In one embodiment, the predefined purity of the sodium nitrite is 99.0-99.9%. In one embodiment, the SNI liquor is 40-46% w/w/Min. In one exemplary embodiment, table 2 below depicts the characteristic/properties of the Sodium nitrite and water used to form the SNI liquor of mass sodium nitrite:

TABLE 2
characteristic/properties of the sodium nitrite and potable water

| | | Quantity | | | | | |
|---|---|---|---|---|---|---|---|
| No | Details | (gms) | Purity | 100% | (MW) | moles | (MR) |
| 1 | Sodium | 1140 | 99.1 | 1130 | 69 | 16.4 | 1.0 |
| | Nitrite | | | | | | |
| | (Dry | | | | | | |
| | Powder) | | | | | | |
| 2 | Potable | 430 | 100 | 430 | 18 | 23.9 | 1.5 |
| | Water | | | | | | |

At step (103), the SNI liquor of mass sodium nitrate may be heated at 40° C.-60° C. under stirring to completely dissolve the dry powder. The same is filtered using Whatman filter of 1-10 micron to remove the foreign particles including black particles. In case of commercial use, the filter may be a duplex cartridge filter with cartridge of 1-10 micron.

At step (104), the SNI liquor of mass sodium nitrite may be transferred to evaporator. In case of lab scale, the SNI liquor of mass sodium nitrite may be transferred to lab scale evaporator. In case of commercial, the SNI liquor of mass sodium nitrite may be transferred to a multi effect evaporator (MEE) or a simple evaporation system with any kind of crystallizer consisting of pre-heaters, calandria, Vapor liquid Separator (VLS), crystallizer, vacuum pump, condensers, salt settlers, and other heat exchangers) to obtain slurry mass of SNI having 30 to 40% free salt concentration.

At step (105), the slurry mass of SNI may be filtered through Whatman filter using Buckner funnel. In commercial batches, the filter may be a centrifuge with fine filtration basket or tub with cloth or without cloth. In one embodiment, the filtration step allows the impurities flow along with the ML and make cake to achieve the quality within the expected range at temperature within a range of 50° C.-65° C. to separate wet cake and Mother Liquor (ML). Further, the ML is kept separate in case of Lab process and in case of commercial batch, the ML goes back to an external SNI liquor of a SNI manufacturing system. The SNI manufacturing system may be external to system implemented for obtaining free flowing food grade SNI. This step makes this process unique in terms of not allowing the undesired impurities to concentrate by virtue of recycling. Further, the final product obtained by this step of filtration is free of these impurities and thereby makes the process capability robust.

At step (106), the wet cake may be dried using a drying unit at temperature 100° C.-140° C. continuously with cold zone operating at 25° C.-60° C. to obtain dry SNI material. In one embodiment, Loss on drying (LOD) may be below 0.2%. Further, in commercial case, wet cake material may be dried using VFBD dryer.

At step (107), the dry SNI material may be coated with a food grade additive in a blender to obtain free-flowing food grade sodium nitrite. In one embodiment, the food grade additive is silica. In commercial case, the blender is ribbon blender and in case of laboratory, small kind of blender is used. Further, in commercial case, the free-flowing food grade sodium nitrite may be packed in bags.

Further, the free-flowing food grade SNI may be analyzed in view of food grade SNI specification.

Now referring to Table 3, the specification of the free-flowing food grade sodium nitrite, is depicted. In one embodiment, the free-flowing food grade sodium nitrite may comprise 99.0-99.9% SNI purity, max 0.70% NaNO3, max 600 ppm alkalinity as NaCO3, max 50 ppm Chloride, max 50 ppm Sulphate, max 0.2% loss on drying, max 0.40% insoluble, max 10 ppm heavy metal-sum of pb, max 0.2 ppm As, max 1 ppm cd, max 1 ppm Pb, max 0.05 ppm Hg, 98.5% to 100.5% assay.

TABLE 3
specification of the free-flowing food grade sodium nitrite

| Sr. No | Details | Characteristics/properties | |
|---|---|---|---|
| 1 | SNI - Purity % | 99.0-99.9% | |
| 2 | SNI-Appearance | White or slightly yellowish | |
| | | crystalline powder | |
| 3 | NaNo3% | 0.70% | Max |
| 4 | Alkalinity as Na2CO3 (ppm) | 600 | ppm Max |
| 5 | Chloride (ppm) | 50 | ppm Max |
| 6 | Sulphate (ppm) | 50 | ppm Max |
| 7 | Loss on drying % | 0.2% | Max |
| 8 | Insoluble | 0.40% | Max |
| 9 | Heavy Metal-Sum as Pb | 10 | ppm Max |
| 10 | As | 0.2 | ppm Max |
| 11 | Cd | 1 | ppm Max |
| 12 | Pb | 1 | ppm Max |
| 13 | Hg | 0.05 | ppm Max |

| | | |
|---|---|---|
| 14 | SiO2 (Anticaking agent) | 0.25-0.35% |
| 15 | Assay | 98.5% to 100.5% |

Now referring to Table 4 below, input and analysis parameters of few lots is depicted. Input parameter such as Quantity and analysis parameters such as sodium nitrite, Sodium nitrate, Alkalinity as Na2CO3 and chloride of plant SNI D-5 dry for lot No 1-5 are represented in the table 3.

TABLE 4
Input and analysis parameter of Lot no 1-5

| Sr. | Plant SNI | | Lot No. | Lot No. | Lot No. | Lot No. | Lot No. |
|---|---|---|---|---|---|---|---|
| No | D-5 dry | Unit | 1 | 2 | 3 | 4 | 5 |
| 1 | Quantity | Kg | 20 | 10 | 4 | 10 | 4 |
| | Analysis | | | | | | |
| 2 | Sodium | % | 99.33 | 99.19 | 99.4 | 99.2 | 99.4 |
| | nitrite | | | | | | |
| 3 | Sodium | | 0.49 | 0.6 | 0.5 | 0.4 | 0.39 |
| | nitrate | | | | | | |
| 4 | Alkalinity as | Ppm | 283 | 333 | 922 | 1008 | 880 |
| | Na2CO3 | | | | | | |
| 5 | Chloride | Ppm | 15 | 47.5 | 67 | 53 | 27 |

Now referring to Table 5, input and analysis parameters of few experiments are depicted. Input parameters such as SNI, potable water, distilled water, SNI wet cake, SNI dry, % recovery and analysis parameters such as sodium nitrate, Alkalinity as Na2CO3 and chloride of SNI for Exp no 1-5 are represented in Table 5.

TABLE 5
input and analysis parameters of Exp 1-5

| Sr. | | | Exp | Exp | Exp | Exp | Exp |
|---|---|---|---|---|---|---|---|
| No | Input | Unit | No. 1 | No. 2 | No. 3 | No. 4 | No. 5 |
| 1 | SNI | Gm | 1140 | 1140 | 1140 | 1140 | 1140 |
| 2 | Potable | Gm | 460 | 460 | 460 | 460 | 460 |
| | water | | | | | | |
| 3 | Distilled | | 0 | 0 | 0 | 0 | 0 |
| | water | | | | | | |
| 4 | SNI wet | Gm | 710 | 695 | 692 | 691 | 687 |
| | cake | | | | | | |
| 5 | SNI dry | Gm | 700 | 685 | 678 | 684 | 676 |
| 6 | % recovery | | 61.4 | 60.1 | 59.5 | 60 | 59.3 |
| | Analysis | | | | | | |
| 7 | Sodium | % | 99.6 | 99.5 | 99.25 | 99.46 | 99.46 |
| | nitrite | | | | | | |
| 8 | Sodium | % | 0.49 | 0.6 | 0.5 | 0.4 | 0.39 |
| | Nitrate | | | | | | |
| 9 | Alkalinity | Ppm | 110 | 101 | 113 | 488 | 194 |
| | as Na2CO3 | | | | | | |
| 10 | Chloride | Ppm | 30 | 15 | 13 | 16 | 13 |

Now referring to table 6, analysis parameters of SNI coating for Exp 1-5 are depicted. Based upon the analysis of parameters values obtained in Exp. No 1, Exp No. 2, Exp. No 3, Exp. No 4, and Exp No 5 represented in below table 6, it is observed that values of NaNO2 (Dry basis), NaNO3, Na2CO3, sulphate, chloride, LOD, insoluble are as per the desired specification of free-flowing food grade SNI.

TABLE 6
analysis parameters of SNI coating for Exp 1-5

| | | Specification | | | | | |
|---|---|---|---|---|---|---|---|
| | SNI coating | of free-flowing | | | | | |
| | Analysis | food grade | Exp | Exp | Exp | Exp | Exp |
| No | parameters | SNI | No. 1 | No. 2 | No. 3 | No. 4 | No. 5 |
| 1 | NaNO2 (Dry | 99.0% Min | 99.15 | 99.08 | 99.1 | 99.05 | 99.03 |
| | basis) (%) | | | | | | |
| 2 | NaNO3 (%) | 0.70% Max | 0.16 | 0.032 | 0.0327 | 0.0325 | 0.15 |
| 3 | Na2CO3 | 600 ppm Max | 110 | 101 | 113 | 488 | 194 |
| | (ppm) | | | | | | |
| 4 | Sulphate | 50 ppm Max | 32 | 38 | 26 | 25 | 40.3 |
| | (ppm) | | | | | | |
| 5 | Chloride | 50 ppm Max | 30 | 15 | 13 | 16 | 13 |
| | (ppm) | | | | | | |
| 6 | LOD (%) | 0.2% Max | 0.2 | 0.18 | 0.19 | 0.12 | 0.2 |
| 7 | Insoluble (%) | 0.40% Max | 0.29 | 0.32 | 0.4 | 0.35 | 0.31 |

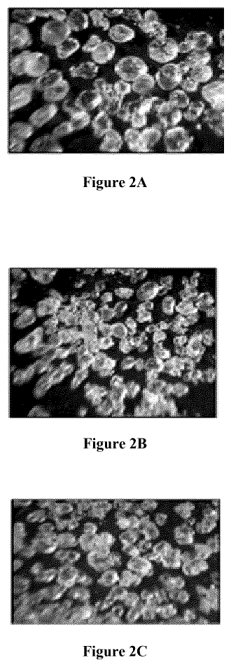

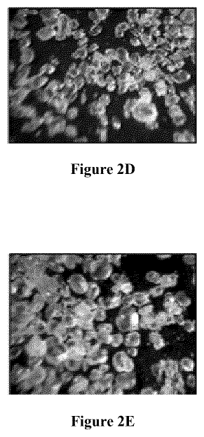

Further, the parametric values such as tap density, untap density, ratio of tap/untap, angle of repose, sieve analysis of SNI coating of the table 6 are observed to be advantageous in obtaining free flowing food grade properties to SNI. Referring to FIG. 2A-2E microscopic images of the free-flowing Sodium nitrate in accordance with Exp. no 1-5 are illustrated.

The brief experimental method followed is as per below:

The SNI technical grade having purity 99-0 to 99.9% is taken from the plant with defined lot. Its initial analysis is as per Table 5. This is dissolved in potable water and evaporated in a laboratory scale evaporator. The slurry is filtered, and the product is dried in specific conditions with addition of food grade additive (such as silica) and the product is analyzed and the results are as per Table 6.

Test-1: Purity testing Method of Sodium Nitrite

In one embodiment, a purity of Sodium nitrite in Table 1 was tested using a following method:

An amount of 3.16 μm KMnO₄ was dissolved in 100 ml D M water. The solution of KMnO₄ were then digested over a hot plate for one hour. The KMnO₄ solution was cooled filtered through Grade 4 sintered glass funnel without applying vacuum for 24 hours. After 24 hours KMnO₄ solution was diluted 1000 ml by demineralized water (DM) water. The solution was standardized same for exact normality of 0.1N. An accurately about 1.0 gm dry sodium nitrite test sample (2.0 to 3.0 μm for liquid) was taken and diluted to 250 ml volumetric flask by Dist. water. A 20 ml of 0.1 N KMnO₄ were taken in solutions in 250 ml beaker and 5 ml of concentrated H₂SO₄ in 50 ml Dist. Water were added. The temperature was maintained to about 40° C. and titration was performed by NaNO₂ solution from Burette, keeping the tip of the burette under the surface of KMnO₄ solution with continuous stirring. NaNO₂ solution were added very slowly. The end point was observed as pink to colourless, and the Burette reading (BR) was noted to obtain results in the Table. 1.

% of sodium nitrite in the dry of sodium nitrite test sample was calculated as below:

$$\% w / w sodium nitrite = \frac{Normality of KMnO 4 \times 34.5 \times 100 \times 250 \times 20}{Gram sample \times 1000 \times B . R .}$$

### Test-2: Loss on Drying (LOD) of Sodium Nitrite

In one embodiment, an amount of loss on drying of all forms Sodium nitrite in Table 1 was tested using a Mettler Toledo Halogen Moisture Analyzer Model-HG-53 and by following method:

Following protocol was followed to test the LOD: Start the instrument, pre-heat the empty aluminium pan (foil) at temp+/−100° C. for five minutes. Then take the quantity mansion in bellow table. Set the temperature & time as mentioned in below table. Press Start key and observe the final reading directly as % loss on drying.

| | Sample | | Time |
|---|---|---|---|
| Sample | quantity | Temp ° C. +/− 2° C. | Minutes |
| NaNO₂ samples | 5 gm | 110 | 10 |
| of Table 1 | | | |

Test-3: Alkalinity by Content of Na₂CO₃ Impurity in the Forms of SNI

In one embodiment, an alkalinity content of all forms Sodium nitrite in Table 1 was tested using a following method:
(a) Reagents used: 0.1 N H₂SO₄ Solution; 0.1 N H₂SO₄ is prepared by mixing 2.82 ml. of pure Sulphuric acid in water and dilute to 1000 ml by distilled water, standardize it.
(b) 0.1% w/v Phenolphthalein indicator solution: Dissolve 0.1 μm of Phenolphthalein powder in 80 ml of 95% methanol and finally dilute to 100 ml with distilled water.

### Protocol Followed:

Weigh accurately nearest to 25 μm of sample and transfer it to 250 ml conical flask. Add 50 ml of distilled water and boil it for five minutes, cool it, and add 4 to 5 drops of Phenolphthalein Indicator. Titrate against 0.1 N Sulphuric acid till pink colour to colourless end point. Note the burette reading (BR).

% Of content of Na2CO3 impurity in the forms of SNI in the dry of sodium nitrite test sample was calculated as below:

$$\% w / w alkalinity as sodium carbonate = \frac{B R \times 2 \times Normality of H 2 SO 4 \times 53 \times 100}{Gram sample \times 1000}$$

### Test-4: Impurity Content of Chloride as Cl

In one embodiment, a chloride content of all forms Sodium nitrite in Table 1 was tested using a following method:

### Reagents Used:

(a) Nitric acid pure (70% w/w)
(b) Standard Silver Nitrate solution-0.1 N: Dissolve 17 μm Silver Nitrate pure in DM water and dilute to 1000 ml in volumetric flask and standardise it.
(c) Nitrobenzene pure
(d) Standard Ammonium thiocyanate solution-0.1 N: Dissolve of 7.6 μm Ammonium thiocyanate pure in 400 ml of DM water and dilute to 1000 ml in volumetric flask and standardize it.
(e) Ferric Ammonium Sulphate indicator saturated solution: Dissolve Ferric Ammonium Sulphate pure in DM water up to saturated solution.

### Protocol Followed:

Weigh accurately nearest to 10 μm of sample (Suitable quantity) in 250 ml conical flask. Add about suitable quantity of Nitric acid depending as product to be analysis till removal of Nitrous gas. Add 10 ml of 0.1 N Silver Nitrate solutions. Add 5.0 ml Nitrobenzene and shake vigorously. Titrate it against 0.1 N Ammonium Thiocyanate solutions, using 1 ml Ferric Ammonium Sulphate indicator solution. Note the burette reading (BR). End point will be faint brown in colour.

% Of content of Chloride (Cl) impurity in the forms of SNI in the dry of sodium nitrite test sample was calculated as below:

$$\% w / w alkalinity as Chloride as Cl = \frac{35.5 \times [ ( N of AgNO 3 \times 10 ) - ( B R \times N of NH 4 SCN ) ] \times 100}{Gram sample \times 1000}$$

### Test-5: Impurity Content of Heavy Metal as Pb

In one embodiment, an impurity content of heavy metal Pb of all forms Sodium nitrite in Table 1 was tested using a following method:

### Reagents Used:

(a) Concentrated Hydrochloric acid pure (30% w/w)
(b) Nitric Acid pure (70% w/w)
(c) Standard lead solution (1 ml=0.01 mg): Dissolve 1.600 μm Lead Nitrate pure in water and 1 ml of concentrated Nitric acid and make the volume up to 1000 ml mark by D M water. Transfer exactly 10 ml of this solution to a 1000 ml volumetric flask, again dilute with D M water and make up the volume to 1000 ml mark. 1 ml of this solution is equivalent to 0.01 mg of Lead (Pb)
(d) 6% w/v Dilute Acetic acid solution: Take 6 ml, acetic acid and dilute it to 100 ml by D M water in volumetric flask.
(e) Hydrogen Sulphide solution: Prepare fresh solution using concentrated Hydrochloric acid and Iron pyrites (Ferrous Sulphide).

### Protocol Followed:

Take 10 μm sample (Suitable quantity) in glass dish add 25 ml D M water, dissolve it, add 25 ml concentrated hydrochloric acid and evaporate to dryness on water-bath until the odor of hydrochloric acid is no longer perceptible. Dissolve the residue in 30 ml DM water; transfer it to 100 ml Nessler cylinder. If solution is dark/black, then solution pass through activated carbon (Charcoal powder) & collect the clear colorless solution. In this clear color solution, add 2 ml dil. Acetic acid & pass H2S gas for 1 minutes & dilute 50 ml mark See the dark colour and compare it with standard colour of Lead.

Standard Lead Colour: Take 10 ml, 20 ml & 50 ml of 1 ml=0.01 mg Lead standard solution in different 100 ml Nessler cylinders, add 2 ml dilute acetic acid, add 10 ml Hydrogen Sulfide solution, or pass H2S gas dilute to 50 ml mark. See the dark colour and compare with above dark colour of sample solution. If sample colour is less than the std colour then sample is passing.

% Of content of Lead as Pb impurity in the forms of SNI in the dry of sodium nitrite test sample was calculated as below:

$$Lead as Pb w / w ppm = \frac{B R \times 0.01 \times 1000}{gm sample}$$

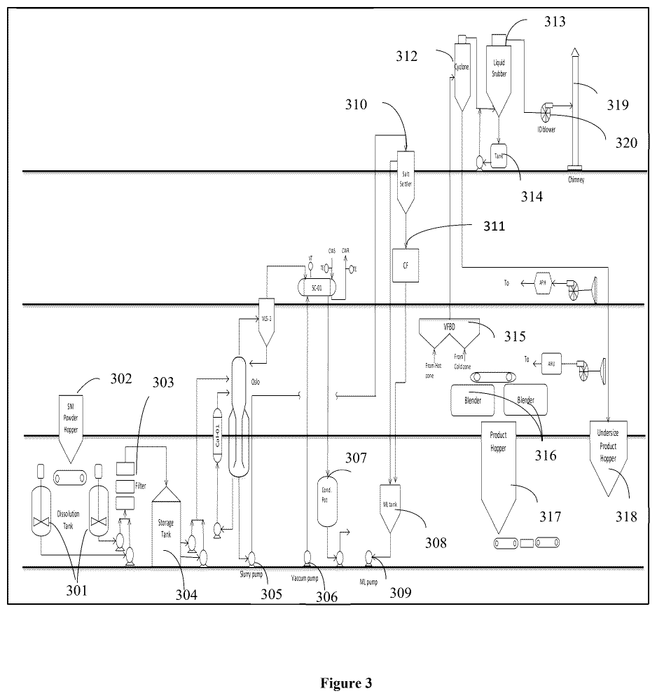

Now referring to FIG. 3, process flow diagram (PFD) depicting an interaction between various components for obtaining a free-flowing food grade sodium nitrite is illustrated, in accordance with an embodiment of the present subject matter.

In one embodiment, the dry powder of SNI is poured into a SNI powder hopper (302). The SNI powder hopper (302) is configured to add dry powder of SNI having 99.0-99.9% purity in the under stirring conditions in the reactor such as dissolution tank (301). The reactor comprises the predefined amount of the charged water. Further, SNI liquor of mass sodium nitrite may be heated at 40° C.-60° C. under stirring to completely dissolve the dry powder. The SNI liquor of mass sodium nitrite may be transferred to storage tank (304) through filters (303) in order to avoid any kind of foreign materials like black particles and other particulates to the tune of 1-4 micron. The SNI liquor of mass sodium nitrite is fed to MEE to concentrate liquor to obtain slurry mass of SNI having 30 to 40% free salt concentration. The slurry mass of SNI is filtered through centrifuge at the temperature within the range of 50° C.-65° C. to separate wet cake and mother liquor (ML), wherein filtration allows the impurities flow along with the ML. The ML is collected in the ML tank (308). The ML goes to an external SNI liquor of a SNI manufacturing system. Further, the wet cake is dried using VFBD (315) at a temperature within the range of 100° C.-140° C. continuously with cold zone operating at 25° C.-60° C. to obtain dry SNI material. More specifically, dried SNI material is transferred to the cyclone tank (312) for centrifuge separation to separate undersized particles. The undersized particles are transferred into an undersized product hopper (318). The dry SNI material is coated with a food grade additive in the blender (316) to obtain free-flowing food grade sodium nitrite. The free-flowing food grade SNI is collected in the product hopper (317).

In one embodiment, sample of free-flowing Food grade Sodium Nitrate is examined using European Pharmacopeia 7.0 (EP 7.0).

### Test 1—Identification

In one embodiment, identification of Sodium nitrite was tested using a following method:
Step 1: Dilute 2.5 gms sample to small qty. of distilled water (or C02 free water), make up to 50 mls of solution A (hereafter referred as Solution S1).
Step 2: Dilute 1 ml of solution A to 25 ml with water to prepare Solution B.
Step 3: Add 0.1 ml of the solution B into 1 ml of sulphonic acid solution, wherein sulphonic acid solution is prepared by mixing 0.5 g of sulphanilic acid, 30 ml of glacial acetic acid and 120 ml of water; heating with stirring until dissolved and further allowed to cool and filter.
Step 4: Allow to stand for 2-3 min.
Step 5: 1 ml of b-naphthol solution R and 1 ml of dilute sodium hydroxide solution.

An intense red colour developed which is indicative of the sample passing of the test.

### Test 2: Appearance of Solution

It is observed that solution S1 is clear.

### Test 3: Acidity or Alkalinity

In one embodiment, acidity or alkalinity of the free-flowing SNI was tested using following method:

Add 0.05 ml of phenol red solution into 10 ml of solution S1. Add 0.1 ml of 0.01 M sodium hydroxide. The solution is red.

Add 0.3 ml of 0.01 M hydrochloric acid. The solution is yellow and the test for acidity and alkalinity is passed.

### Test 4: Chloride

In one embodiment, an amount of Chloride in the free-flowing SNI was tested using following method:

Dissolve 3 g sample in distilled water. Continuously add 10 ml of Nitric acid and evaporate to dryness. Dissolve the residue in 10 ml of distilled water R, neutralize with sodium hydroxide solution and dilute to 30 ml with distilled water which is solution S2
Step 1: Dilute 10 ml of solution S2 to 15 ml with water. The solution complies with the limit test for chlorides.
Step 2: Add 1 ml of dilute nitric acid R into 15 ml of the prescribed solution of step 1.
Step 3: Pour the mixture as a single addition into test tube containing 1 ml of silver nitrate solution R2.
Step 4: Prepare a standard in the same manner using 10 ml of chloride standard solution (5 ppm) R and 5 ml of water R.
Step 5: Examine the tubes laterally against a black background.

Result of this test indicates an amount of Chloride is less than 50 ppm in free-flow SNI. This result complies with the standard specification of sulphate in food grade SNI which is maximum 50 ppm.

### Test 5: Sulphates

In one embodiment, amount of sulphates in the free-flowing SNI was tested using following method:
Step 1: Dilute 7.5 ml of solution S2 to 15 ml with distilled water R. The solution complies with the limit test for sulphates.
Step 2: Add 3 ml of a 250 g/l sodium of barium chloride R to 4.5 ml of sulphate standard solution (10 ppm SO₄) R1. Shake and allow to stand for 1 min.
Step 3: Add 15 ml of the solution to 2.5 ml of this solution and 0.5 ml of acetic acid R.
Step 4: Prepare a standard in the same manner using 15 ml of sulphate standard solution (10 ppm SO₄) R instead of the solution to be examined.
Step 5: After 5 min, any opalescence in the test solution is not more intense than that in the standard.

Result of this test indicates an amount of sulphate is less than 100 ppm in free-flow SNI. This result complies with the standard specification of sulphate in food grade SNI which is maximum 200 ppm.

### Test 6: Heavy Metals (pb)

In one embodiment, amount of heavy metals (pb) in the free-flowing SNI was tested using following method:
Step 1: Dissolve 1 g in 6 mL of 3 N hydrochloric acid and evaporate on a steam bath to dryness.
Step 2: Reduce the residue to a course powder and continue heating on the steam bath until the odour of hydrochloric acid no longer is perceptible.
Step 3: Dissolve the residue in 23 ml of water and add 2 mL of IN acetic acid: compare with std. 10 ppm solution with above process.

Result of this test indicates the amount of heavy metal is less than 1 ppm in the free-flow SNI. The result complies with the standard specification of heavy metals (pb) in food grade SNI which is maximum 20 mg/kg.

### Test 7: Loss on Drying

In one embodiment, Loss on drying in the free-flowing SNI was tested using following method:

Food grade SNI is dried over silica gel for 4 hours. It loses not more than 1% of its weight i.e. 0.066.

### Test 8: Assay

In one embodiment, assay in the free-flowing SNI was tested using following method:
Step 1: Dissolve 0.400 g in 100.0 ml of water R.
Step 2: Introduce 20.0 ml of the solution into a conical flask containing 30.0 ml of 0.1 M cerium sulphate, while stirring continuously and keeping the tip of the pipette below the surface of the liquid.
Step 3: Immediately stop the flask and allow to stand for 2 min.
Step 4: Add 10 ml of 200 g/l solution of potassium iodide R and 2 ml of starch solution R.

While stirring continuously, titrate with 0.1 M Sodium Thiosulphate until the blue colour disappears. Carry out a blank titration. 1 ml of 0.1 M Cerium Sulphate is equivalent to 3.45 mg of NaNO₂.

Result of this test indicates the amount of assay is 99.16% (Dry basis) in the free-flow SNI. The result complies with the standard specification of assay in food grade SNI which is 98.5% to 100.5% (dried substance).

In another embodiment, sample of free-flowing Food grade Sodium Nitrate is examined using USP-29.

### Test 1—Identification

In one embodiment, identification of Sodium nitrite was tested using a following method:
Step 1: Dilute 2.5 gms sample of distilled water, make up to 50 mls of solution A.
Step 2: Dilute 1 ml of solution A to 25 ml with water to prepare solution B.
Step 3: Add 0.1 ml of the solution B 1 ml of sulphonic acid solution. Sulphanilic Acid Solution is prepared by mixing 0.5 g of sulphanilic acid, 30 ml of glacial acetic acid and 120 ml of water and heat with stirring until dissolved and allowed to cool and filter.
Step 4: Allow to stand for 2-3 min.
Step 5: Add 1 ml of b-naphthol solution R and 1 ml of dilute sodium hydroxide solution R.

An intense red colour is developed which is indicative of the sample passing of the test.

### Test 2: Loss on Drying

In one embodiment, Loss on drying in the free-flowing SNI was tested using following method:

Food grade SNI is dried over silica gel for 4 hours. It loses not more than 0.25% of its weight i.e. 0.083.

### Test 3: Heavy Metals (pb)

Step 1: Dissolve 1 g in 6 mL of 3 N hydrochloric acid and evaporate on a steam bath to dryness.
Step 2: Reduce the residue to a course powder and continue heating on the steam bath until the odor of hydrochloric acid no longer is perceptible.
Step 3: Dissolve the residue in 23 mL of water and add 2 mL of 1 N acetic acid: Compare with std. 10 ppm solution with above process.

Result of this test indicates the amount of heavy metal is less than 0.0001 in the free-flow SNI. The result complies with the standard specification of heavy metal in food grade SNI which is maximum 0.0020%.

### Test 4: Assay

Step 1: Dissolve about 1 g of Sodium Nitrite, accurately weighed, in water to make 100.0 mls.
Step 2: Pipette 10 mL of the Sodium Nitrite solution into a mixture of 50.0 mL of 0.1 N potassium permanganate VS, 100 mL of water, and 5 mL of sulfuric acid. When adding the Sodium Nitrite solution, immerse the tip of the pipette beneath the surface of the permanganate mixture.
Step 3: Warm the liquid to 40, allow it to stand for 5 minutes, and add 25.0 mL of 0.1 N oxalic acid VS.
Step 4: Heat the mixture to about 80, and titrate with 0.1 N potassium permanganate VS.

Each mL of 0.1 N potassium permanganate is equivalent to 3.450 mg of NaNO2.

Result of this test indicates the amount of assay is 99.03% (Dry basis) in the free-flow SNI. The result complies with the standard specification of assay in food grade SNI which is 97% to 101% (dried substance).

In accordance with embodiments of the present disclosure, a method for obtaining of free-flowing food grade sodium nitrite described above may have following advantages including but not limited to:
The moisture content of the free-flowing food grade sodium nitrite may not be greater than 0.2%.
The store shelf life of the free-flowing food grade SNI may be improved.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated but is to be accorded the widest scope consistent with the principles and features described herein.

The embodiments, examples and alternatives of the preceding paragraphs, the description, including any of their various aspects or respective individual features, may be taken independently or in any combination. Features described in connection with one embodiment are applicable to all embodiments unless such features are incompatible.

The foregoing description shall be interpreted as illustrative and not in any limiting sense. A person of ordinary skill in the art would understand that certain modifications could come within the scope of this disclosure. The embodiments, examples and alternatives of the preceding paragraphs or the description and drawings, including any of their various aspects or respective individual features, may be taken independently or in any combination. Features described in connection with one embodiment are applicable to all embodiments, unless such features are incompatible.

1. A method of obtaining a free-flowing food grade sodium nitrite, wherein the method comprising steps of:
charging a predefined amount of water in a reactor;
adding dry powder of sodium nitrite (SNI) having predefined purity in the reactor under stirring conditions to obtain SNI liquor of mass sodium nitrite;
heating the SNI liquor of mass sodium nitrite at 40-60° C. under stirring to completely dissolve the dry powder and transfer to evaporator feed tank through filters;
feeding the SNI liquor of mass sodium nitrite in the evaporator to concentrate liquor to obtain slurry mass of SNI having 30 to 40% free salt concentration;
filtering the slurry mass of SNI through centrifuge at a temperature within a range of 50° C.-65° C. to separate wet cake and mother liquor (ML), wherein the ML goes back to an external SNI liquor;
drying the wet cake using a drying unit at a temperature within a range of 100° C.-140° C. continuously with cold zone operating at 25-60° C. to obtain dry SNI material; and
coating the dry SNI material with a food grade additive in a blender to obtain free-flowing food grade sodium nitrite.

2. The method as claimed in claim 1, wherein the predefined purity of the sodium nitrite is 99.0%-99.9%.

3. The method as claimed in claim 1, wherein the SNI liquor of mass sodium nitrite is transferred to feed tank through filters in order to avoid foreign materials including black particles and other particulates to tune of 1-4 micron.

4. The method as claimed in claim 1, wherein the wet cake is having moisture content 1-12%.

5. The method as claimed in claim 1, wherein the wet cake material is dried using Vibratory Fluidized Bed Dryer (VFBD).

6. The method as claimed in claim 1, wherein the food grade additive is silica.

7. The method as claimed in claim 1, wherein the free-flowing food grade sodium nitrite is packed in bags.

8. The method as claimed in claim 1, wherein the free-flowing food grade Sodium nitrite is analyzed in view of food grade SNI specification.

9. The method as claimed in claim 1, wherein the free-flowing food grade sodium nitrite comprising:
sodium nitrate (SNI) having purity of 99.0-99.9%, wherein NaNO3 is no greater than 0.70%, wherein alkalinity as Na2CO3 is no greater than 600 ppm, wherein a chloride content is no greater than about 50 ppm, wherein a sulphate content is no greater than 50 ppm, wherein loss on drying is no greater than 0.2%, wherein a content of insoluble is no greater than 0.4%, wherein a content of a heavy metal is no greater than 10 ppm, wherein a content of assay is within a range of 98.5% to 100.5%.

10. The method as claimed in claim 9, wherein the heavy metal is at least Lead (pb).

11. The method as claimed in claim 9, wherein a content of Cadmium (cd) is no greater than 1 ppm, wherein a content of Lead (pb) is no greater than 1 ppm, wherein a content of Mercury (Hg) is no greater than 0.05 ppm.
